(19) United States
(12) Patent Application Publication
(10) Pub. No.: US 2025/0001660 A1
(43) Pub. Date: Jan. 2, 2025

(54) LONG MOLDED ARTICLE AND METHOD FOR MANUFACTURING LONG MOLDED ARTICLE

(71) Applicants: Tokai Kogyo Co., Ltd., Obu-shi (JP); Takarakasei Kogyo Co., Ltd., Nishio-shi (JP)

(72) Inventors: Kohji KAMIYA, Obu-shi (JP); Koki Nakamichi, Obu-shi (JP); Renji Maki, Nishio-shi (JP)

(73) Assignees: Tokai Kogyo Co., Ltd., Obu-shi (JP); Takarakasei Kogyo Co., Ltd., Nishio-shi (JP)

(21) Appl. No.: 18/754,917

(22) Filed: Jun. 26, 2024

(30) Foreign Application Priority Data
Jun. 27, 2023 (JP) 2023-104604
Jan. 19, 2024 (JP) 2024-006472

(51) Int. Cl. B29C 45/14; B29C 45/17; B29K 21/00; B29L 31/30; B60R 13/04

(52) U.S. Cl. CPC B29C 45/14336; B29C 45/14065; B29C 45/1703; B29C 2045/14139; B29K 2021/003; B29K 2995/007; B29L 2031/3041; B60R 13/04

(57) ABSTRACT

A long molded article includes: a main body portion and an end covering portion. A wall portion of the main body portion includes an outer surface defining in part an exposed surface and an inner wall surface defining a hollow portion formed therein. The end covering portion is integrated with and covers a joint portion provided in a part of the wall portion defining one end portion of the hollow portion or a vicinity thereof. A first thickness between the outer surface and the inner wall surface in a first portion of the joint portion in a vicinity of an inner end portion is set to be thicker than a second thickness in a second portion of the joint portion on an outer end portion side relative to the first portion.

### CROSS-REFERENCE TO RELATED APPLICATIONS

This application is based on and claims priority under 35 USC 119 from Japanese Patent Application No. 2023-104604 filed on Jun. 27, 2023 and Japanese Patent Application No. 2024-006472 filed on Jan. 19, 2024, the contents of which are incorporated herein by reference.

### TECHNICAL FIELD

The present disclosure relates to a long molded article (for example, a pillar garnish) in which a long main body portion and an end covering portion (for example, an airflow adjuster) are integrated by injection molding the end covering portion at one end of the main body portion, and a method for manufacturing a long molded article.

### BACKGROUND ART

For example, JP2003-165137A (see FIGS. 1 to 4 and paragraphs 0026 to 0031 of the patent literature) discloses a window edge molding for a vehicle as a long composite molded article. The window edge molding includes a long molding body and an end covering portion integrated with an end portion of the molding body so as to cover the end portion. The molding body is formed by gas injection molding, and a hollow portion is defined between a covering portion providing a design surface and a rear wall. The end covering portion is formed by performing additional injection molding on the molding body.

### SUMMARY OF INVENTION

In the window edge molding according to JP2003-165137A, the hollow portion exists behind the covering portion of the molding body, and thus the rigidity of the covering portion is not very high. Therefore, when the end covering portion is formed by injection molding on an outer surface (design surface) of the covering portion of the molding body, the outer surface of the covering portion may be dented (that is, caved in) by the injection pressure or heat generated by a molten polymer material forming the end covering portion. At this time, a portion on the outer surface of the covering portion that is not covered with the end covering portion may be dented. If the molten polymer material forming the end covering portion enters a dent portion of the covering portion that is not covered by the end covering portion and solidifies as it is, burrs are generated by the solidified polymer material. The generation of the burrs will be described later with reference to FIGS. 10A to 10C.

An object of the present disclosure is to provide a long molded article capable of preventing or reducing generation of burrs in a joint region between a main body portion and an end covering portion, and a method for manufacturing a long molded article.

In a first aspect of the present disclosure, there is provided a long molded article including: a main body portion extending in a longitudinal direction; and an end covering portion located at one end of the main body portion in the longitudinal direction, wherein the main body portion includes a wall portion, wherein the wall portion includes an outer surface on an outer side of the wall portion and an inner wall surface on an inner side of the wall portion, a part of the outer surface defining an exposed surface exposed to an outside of the long molded article, the inner wall surface defining a hollow portion formed inside the main body portion and extending along the longitudinal direction, wherein a joint portion configured to be joined to the end covering portion is provided in a part of the wall portion at the one end of the main body portion, the part of the wall portion defining one end portion of the hollow portion in the longitudinal direction or a vicinity of the one end portion, wherein the end covering portion is an injection molded portion, the injection molded portion being made of an elastic polymer material having a hardness lower than a material constituting the main body portion and being integrated with the joint portion while covering the joint portion, wherein the joint portion includes an outer end portion and an inner end portion, the inner end portion being located opposite to the outer end portion in the longitudinal direction and being adjacent to the exposed surface, and wherein a first thickness between the outer surface and the inner wall surface in a first portion of the joint portion, the first portion being located in a vicinity of the inner end portion of the joint portion, is set to be thicker than a second thickness between the outer surface and the inner wall surface in a second portion of the joint portion, the second portion being located adjacent to the first portion of the joint portion on an outer end portion side relative to the first portion.

According to the first aspect of the present disclosure, the first portion located in the vicinity of the inner end portion of the joint portion located at the one end of the main body portion is relatively thick and has high rigidity. Therefore, even when the end covering portion is injection molded with respect to the joint portion so as to cover the joint portion, the wall portion forming the first portion of the joint portion is less likely to be dented by the injection pressure of the elastic polymer material for the end covering portion. Accordingly, it is possible to prevent or reduce the generation of burrs protruding toward the exposed surface side in the joint region between the main body portion and the end covering portion.

In a second aspect of the present disclosure, the outer surface may have a recessed portion formed in the second portion of the joint portion and recessed relative to the inner end portion of the joint portion such that the inner end portion is made thicker than the second portion.

According to the second aspect of the present disclosure, the following effects are obtained in addition to the effects of the first aspect of the present disclosure. That is, by forming the recessed portion recessed relative to the inner end portion of the joint portion at the second portion of the joint portion, the inner end portion of the joint portion can be relatively thickened easily.

In a third aspect of the present disclosure, there is provided a method for manufacturing a long molded article, the method including: preparing a main body portion extending in a longitudinal direction, wherein: the main body portion includes a wall portion, the wall portion includes an outer surface on an outer side of the wall portion and an inner wall surface on an inner side of the wall portion, a part of the outer surface defining an exposed surface to be exposed to an outside of the long molded article, the inner wall surface defining a hollow portion formed inside the main body portion and extending along the longitudinal direction, a joint portion is provided in a part of the wall portion at one end of the main body portion in the longitudinal direction, the part of the wall portion defining one end portion of the hollow portion in the longitudinal direction or a vicinity of the one end portion, and the joint portion includes an outer end portion and an inner end portion, the inner end portion being located opposite to the outer end portion in the longitudinal direction and adjacent to the exposed surface, and a first thickness between the outer surface and the inner wall surface in a first portion of the joint portion, the first portion being located in a vicinity of the inner end portion of the joint portion, is set to be thicker than a second thickness between the outer surface and the inner wall surface in a second portion of the joint portion, the second portion being located adjacent to the first portion of the joint portion on an outer end portion side relative to the first portion; setting the main body portion in an injection mold, the injection mold having a cavity configured to mold an end covering portion to be located at the one end of the main body portion; and injecting a polymer material into the cavity of the injection mold after the setting the main body portion in the injection mold, the polymer material being an elastic polymer material having a hardness lower than that of a material constituting the main body portion, to injection mold the end covering portion using the polymer material such that the end covering portion is integrated with the joint portion while covering the joint portion.

According to the third aspect of the present disclosure, the first portion located in the vicinity of the inner end portion of the joint portion located at the one end of the main body portion prepared in the preparing the main body portion is relatively thick and has high rigidity. Therefore, in the injection molding the end covering portion with respect to the joint portion so as to cover the joint portion, the wall portion forming the first portion of the joint portion is less likely to be dented by the injection pressure of the elastic polymer material for the end covering portion. Therefore, according to the method, it is possible to prevent or reduce the generation of burrs protruding toward the exposed surface side in the joint region between the main body portion and the end covering portion.

In a fourth aspect of the present disclosure, in the preparing the main body portion, the main body portion may be prepared by gas-assisted injection molding.

According to the fourth aspect of the present disclosure, the following effects are obtained in addition to the effects of the third aspect of the present disclosure. That is, according to the gas-assisted injection molding, the main body portion having the hollow portion extending along the longitudinal direction therein can be easily molded.

In a fifth aspect of the present disclosure, the outer surface may have a recessed portion formed in the second portion of the joint portion and recessed relative to the inner end portion of the joint portion such that the inner end portion is made thicker than the second portion.

According to the fifth aspect of the present disclosure, the following effects are obtained in addition to the effects of the third aspect of the fourth aspect of the present disclosure. That is, by forming the recessed portion recessed relative to the inner end portion of the joint portion at the second portion of the joint portion, the inner end portion of the joint portion can be relatively thickened easily.

In a sixth aspect of the present disclosure, the preparing the main body portion may include injection molding the main body portion such that the recessed portion includes a bottom surface formed as an inclined surface non-parallel to the exposed surface.

According to the sixth aspect of the present disclosure, the following effects are obtained in addition to the effects of the fifth aspect of the present disclosure. That is, in a case where the main body portion is molded by injection molding, when a polymer material serving as the material for the main body portion in a molten state is injected and supplied toward a mold surface for molding the bottom surface (that is, the inclined surface non-parallel to the exposed surface of the main body portion) of the recessed portion provided in the second portion of the joint portion, the inclined mold surface preferentially guides or leads the molten polymer material to a side opposite to the exposed surface (that is, toward an outer end portion side of the joint portion). Therefore, during the injection molding of the main body portion, it is possible to prevent a flow mark from appearing on the exposed surface and to prevent the deterioration in appearance.

In a seventh aspect of the present disclosure, there is provided a long molded article including: a main body portion extending in a longitudinal direction; and an end covering portion located at one end of the main body portion in the longitudinal direction, wherein the main body portion includes a wall portion, the wall portion forming at least a head portion and a body portion on a back surface side of the head portion, wherein the wall portion includes an outer surface on a front surface side of the head portion and an inner wall surface on an inner side of the wall portion such that a part of the head portion forming the outer surface defines an exposed surface exposed to an outside of the long molded article, the inner wall surface defining a hollow portion formed inside the main body portion and extending along the longitudinal direction, wherein a joint portion configured to be joined to the end covering portion is provided in a part of the wall portion at the one end of the main body portion, the part of the wall portion defining one end portion of the hollow portion in the longitudinal direction or a vicinity of the one end portion, wherein the end covering portion is an injection molded portion, the injection molded portion being made of an elastic polymer material having a hardness lower than a material constituting the main body portion and being integrated with the joint portion while covering the joint portion, wherein the joint portion includes an outer end portion and an inner end portion, the inner end portion being located opposite to the outer end portion in the longitudinal direction and being adjacent to the exposed surface, wherein a first thickness between the outer surface and the inner wall surface in a first portion of the joint portion, the first portion being located in a vicinity of the inner end portion of the joint portion, is set to be thicker than a second thickness between the outer surface and the inner wall surface in a second portion of the joint portion, the second portion being located adjacent to the first portion of the joint portion on an outer end portion side relative to the first portion, wherein the outer surface has a recessed portion formed in the second portion of the joint portion and recessed relative to the inner end portion of the joint portion such that the inner end portion is made thicker than the second portion, and wherein in a region where the recessed portion is formed, a lump portion is formed at a position of the outer surface corresponding to a portion that does not face the body portion.

According to the seventh aspect of the present disclosure, the first portion located in the vicinity of the inner end portion of the joint portion located at the one end of the main body portion is relatively thick and has high rigidity. Therefore, even when the end covering portion is injection molded with respect to the joint portion so as to cover the joint portion, the wall portion forming the first portion of the joint portion is less likely to be dented by the injection pressure of the elastic polymer material for the end covering portion. Accordingly, it is possible to prevent or reduce the generation of burrs protruding toward the exposed surface side in the joint region between the main body portion and the end covering portion. Further, in a region of the joint portion of the main body portion where the recessed portion is formed, the lump portion is formed at the position of the outer surface corresponding to the portion that does not face the body portion of the main body portion. Therefore, even in a case where the main body portion is prepared by injection molding, it is possible to prevent a weld line from generating on the exposed surface of the main body portion. That is, the design of the exposed surface is not impaired by the weld line.

In an eighth aspect of the present disclosure, there is provided a method for manufacturing a long molded article, the method including: preparing a main body portion extending in a longitudinal direction, wherein: the main body portion includes a wall portion, the wall portion forming at least a head portion and a body portion on a back surface side of the head portion, the wall portion includes an outer surface on a front surface side of the head portion and an inner wall surface on an inner side of the wall portion such that a part of the head portion forming the outer surface defines an exposed surface exposed to an outside of the long molded article, the inner wall surface defining a hollow portion formed inside the main body portion and extending along the longitudinal direction, a joint portion is provided in a part of the wall portion at one end of the main body portion in the longitudinal direction, the part of the wall portion defining one end portion of the hollow portion in the longitudinal direction or a vicinity of the one end portion, the joint portion includes an outer end portion and an inner end portion, the inner end portion being located opposite to the outer end portion in the longitudinal direction and being adjacent to the exposed surface of the head portion, a first thickness between the outer surface and the inner wall surface in a first portion of the joint portion, the first portion being located in a vicinity of the inner end portion of the joint portion, is set to be thicker than a second thickness between the outer surface and the inner wall surface in a second portion of the joint portion, the second portion being located adjacent to the first portion of the joint portion on an outer end portion side relative to the first portion of the joint portion, the outer surface has a recessed portion formed in the second portion of the joint portion and recessed relative to the inner end portion of the joint portion such that the inner end portion is made thicker than the second portion, and in a region where the recessed portion is formed, a lump portion is formed at a position of the outer surface corresponding to a portion that does not face the body portion; setting the main body portion in an injection mold, the injection mold having a cavity configured to mold an end covering portion to be located at the one end of the main body portion; and injecting a polymer material into the cavity of the injection mold after the setting the main body portion in the injection mold, the polymer material being an elastic polymer material having a hardness lower than that of a material constituting the main body portion, to injection mold the end covering portion using the polymer material such that the end covering portion is integrated with the joint portion while covering the joint portion.

According to the eighth aspect of the present disclosure, the first portion located in the vicinity of the inner end portion of the joint portion located at the one end of the main body portion prepared in the preparing the main body portion is relatively thick and has high rigidity. Therefore, in the injection molding the end covering portion with respect to the joint portion so as to cover the joint portion, the wall portion forming the first portion of the joint portion is less likely to be dented by the injection pressure of the elastic polymer material for the end covering portion. Therefore, according to the method, it is possible to prevent or reduce the generation of burrs protruding toward the exposed surface side in the joint region between the main body portion and the end covering portion. Further, in a region of the joint portion of the main body portion where the recessed portion is formed, the lump portion is formed at the position of the outer surface corresponding to the portion that does not face the body portion of the main body portion. Therefore, even in a case where the main body portion is prepared by injection molding, it is possible to prevent a weld line from generating on the exposed surface of the main body portion.

As described above in detail, according to the long molded article and the method for manufacturing the long molded article of the present disclosure, it is possible to prevent or reduce the generation of burrs in a joint region between the main body portion and the end covering portion.

### BRIEF DESCRIPTION OF DRAWINGS

The present disclosure will be described in detail based on the following without being limited thereto, wherein:

FIG. 1 is a perspective view showing a pillar garnish mounted on a vehicle body;

FIG. 2 is an overall view of the pillar garnish according to an embodiment of the present disclosure;

FIG. 3 is a schematic cross-sectional view taken along a line III-III in FIG. 2;

FIG. 4A is an enlarged view of the vicinity of an end of the pillar garnish of FIG. 2, and FIG. 4B is an enlarged view of the vicinity of an end of a main body portion of the pillar garnish (before an end covering portion is formed);

FIG. 5 is a schematic cross-sectional view taken along a line V-V in FIG. 4A;

FIG. 6 is a cross-sectional view showing an outline of an injection mold for molding the main body portion of the pillar garnish (in particular, the vicinity of the end of the main body portion);

FIG. 7 is a schematic cross-sectional view corresponding to FIG. 5 showing another embodiment (Another Example 1) of the present disclosure;

FIGS. 8A and 8B show another embodiment (Another Example 2) of the present disclosure, in which FIG. 8A is a schematic cross-sectional view of the vicinity of an end of a main body portion of a pillar garnish (before an end covering portion is formed), and FIG. 8B is a schematic cross-sectional view corresponding to FIG. 5;

FIG. 9 is a schematic cross-sectional view corresponding to FIG. 5 showing another embodiment (Another Example 3) of the present disclosure;

FIGS. 10A, 10B, and 10C are a series of cross-sectional views illustrating a situation in which burrs are likely to be generated in an example in the related art;

FIGS. 11A and 11B are diagrams showing a problem to be solved by another embodiment (Another Example 4) of the present disclosure, in which FIG. 11A is a schematic diagram corresponding to FIG. 4B, and FIG. 11B is an enlarged plan view of the vicinity of an end shown in FIG. 11A;

FIG. 12 is an enlarged plan view of the vicinity of an end of a main body portion of a pillar garnish (before an end covering portion is formed) showing the other embodiment (Another Example 4) of the present disclosure; and

FIG. 13 is an enlarged perspective view of the vicinity of the end of the main body portion of the pillar garnish shown in FIG. 12 (before the end covering portion is formed).

### DESCRIPTION OF EMBODIMENTS

Hereinafter, several embodiments of the present disclosure will be described with reference to the drawings.

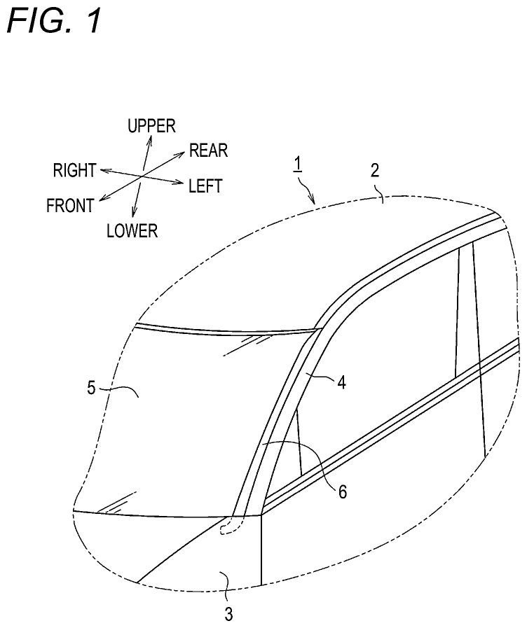

FIG. 1 is a view of a part of a cabin (passenger room) of a general passenger vehicle as viewed obliquely from the front. As shown in FIG. 1, front pillars 4 (also referred to as “A pillars”, and only a left front pillar is shown) extending in an inclined state from a front end of a roof panel 2 to a rear end edge of a fender panel 3 are provided on both left and right sides of a vehicle 1, respectively. A front window glass 5 (hereinafter referred to as a “window pane”) is provided between the left and right front pillars 4 in front of the cabin of the vehicle 1. A pillar garnish 6 is attached to fill a gap that may occur between an outer peripheral edge of the window pane 5 and the front pillar 4. The pillar garnish 6 is a long molded article made of resin which is interposed between the front pillar 4 and the window pane 5 to ensure a decorative function, a waterproof function, and other functions.

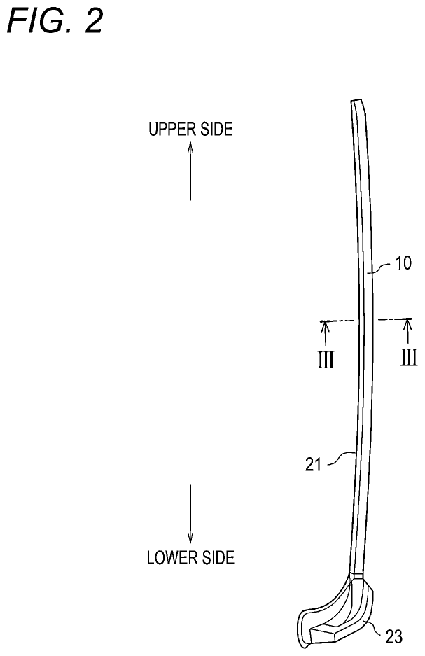

As shown in FIGS. 1 to 3, the pillar garnish 6 includes a long main body portion 10 extending from an upper side to a lower side along the front pillar 4, and an airflow adjuster 23 serving as an end covering portion located at one end (lower end in FIG. 2) of the main body portion 10. When the pillar garnish 6 is attached to a vehicle body, the airflow adjuster 23 is disposed between a front corner portion of the window pane 5 and the fender panel 3, and functions to cover a gap between the two and to adjust an airflow from the front of the vehicle body.

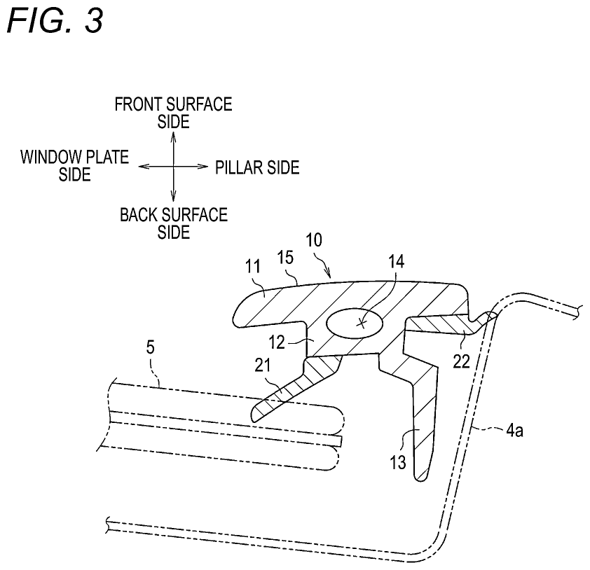

As shown in FIGS. 2 and 3, the main body portion 10 of the pillar garnish includes a head portion 11, a body portion 12, and a leg portion 13 which are arranged in this order from a front surface side toward a back surface side, and a hollow portion 14 extending in a longitudinal direction is formed mainly at the center of the body portion. The main body portion 10 provided with the hollow portion 14 may be molded by so-called gas-assisted injection molding (full shot method or short shot method). Specifically, when a molten polymer material as a molding material is injected into and fills a cavity of an injection mold for molding the main body portion (for example, see FIG. 6), a gas (for example, nitrogen gas) is simultaneously injected, so that the main body portion having the hollow portion as described above can be obtained.

The head portion 11 of the main body portion 10 is a portion disposed on the outermost side when the pillar garnish 6 is attached to the vehicle body, and a design surface 15 (that is, an exposed surface 15 exposed to the outside) is provided by an upper surface of the head portion 11.

Further, a window pane side cushion portion 21 and a pillar side cushion portion 22 are provided on both sides of the main body portion 10 in a width direction. The cushion portions 21 and 22 are long portions extending along the longitudinal direction of the main body portion 10, and ends of the cushion portions are both connected to the airflow adjuster 23. That is, the airflow adjuster 23 and the cushion portions 21 and 22 are made of the same material. The window pane side cushion portion 21 abuts against the window pane 5, and the pillar side cushion portion 22 abuts against a vehicle body panel 4a of the front pillar. Each of the cushion portions 21 and 22 prevents the window pane 5 and the vehicle body panel 4a from being damaged, and also prevents generation of abnormal noise caused by vibration during traveling of the vehicle.

As a material for the main body portion 10, a polymer material that is more rigid and harder than the material for the cushion portions 21 and 22 and the airflow adjuster 23 is suitable. Examples of usable polymer materials include thermoplastic resins such as acrylonitrile butadiene styrene resin (ABS resin), acrylonitrile ethylene propylene styrene resin (AES resin), rigid or semi-rigid polyvinyl chloride resin (Rigid PVC resin), polycarbonate resin (PC resin), polypropylene resin (PP resin), polyethylene resin (PE resin), polystyrene resin (PS resin), polyamide resin (PA resin), and poly methyl methacrylate resin (PMMA resin).

Further, as the material for the cushion portions 21 and 22 and the airflow adjuster 23, an elastic polymer material that is less hard and more flexible than the material for the main body portion 10 is suitable. Examples of usable elastic polymer materials include thermoplastic synthetic resins such as olefin-based thermoplastic elastomer (TPO), styrene-based thermoplastic elastomer (TPS), and soft polyvinyl chloride resin (PVC), and rubbers.

It is preferable to select a combination in which the material for the cushion portions 21 and 22 and the airflow adjuster 23 and the material for the main body portion 10 have good compatibility with each other.

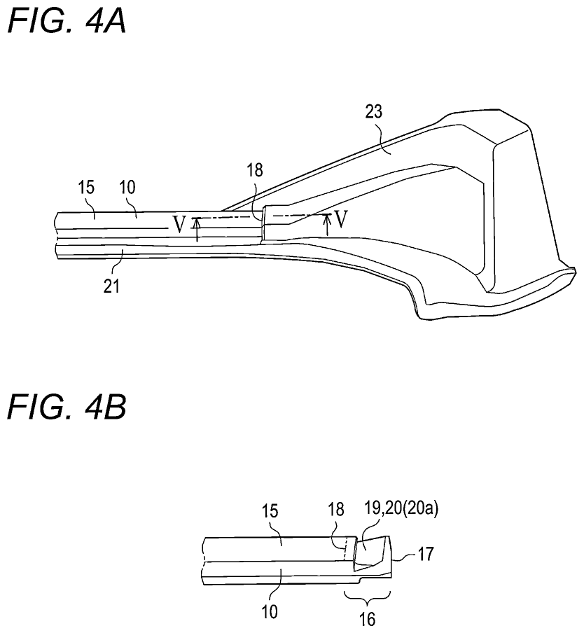

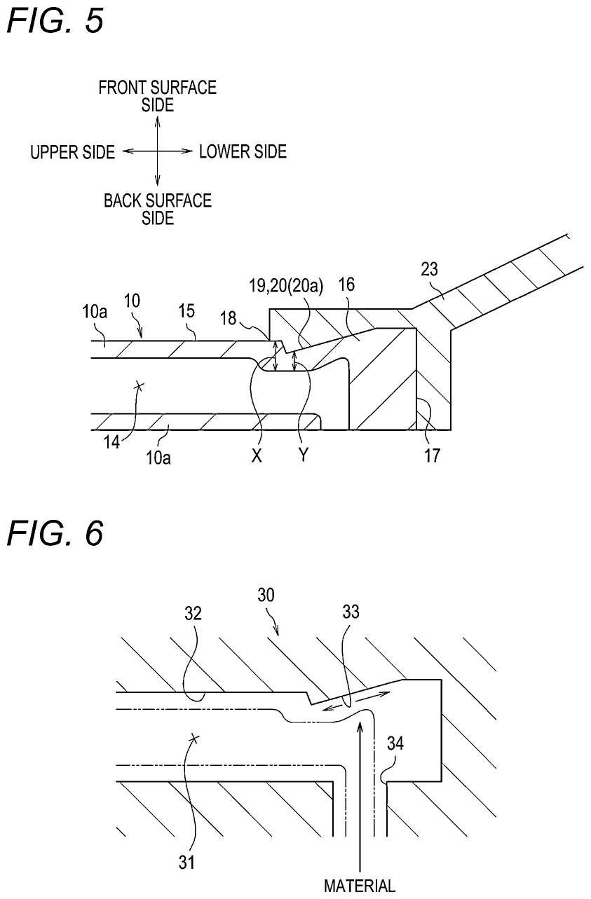

FIGS. 4A, 4B and 5 schematically show the vicinity of an end of the pillar garnish 6. The main body portion 10 of the pillar garnish 6 has a long hollow portion 14 extending along the longitudinal direction therein, and the hollow portion 14 is surrounded and defined by a wall portion (or a flesh portion) 10a of the main body portion 10. At one end of the long main body portion 10, a joint portion 16 for joining to the end covering portion (airflow adjuster 23) is provided on a wall portion that defines one end portion of the long hollow portion 14 or the vicinity thereof. In particular, as shown in FIG. 5, the joint portion 16 includes two end portions (17 and 18) in the longitudinal direction of the main body portion 10, specifically, an outer end portion 17 and an inner end portion 18 located on the opposite side of the outer end portion 17 and adjacent to the design surface 15 of the main body portion. Further, on the front surface side of the joint portion 16, a recessed portion 20 recessed with respect to a surface of the inner end portion 18 (or the design surface 15 continuous with the surface of the inner end portion) is formed at an outer end side portion 19 adjacent to the inner end portion 18 (in other words, slightly shifted from the inner end portion 18 toward the outer end). As a result, as shown in FIG. 5, a thickness (X, an example of a first thickness) between an outer surface of the main body portion and an inner wall surface of the hollow portion in the vicinity of the inner end portion 18 (an example of a first portion) of the joint portion 16 is larger than a thickness (Y, an example of a second thickness) between the outer surface of the main body portion and the inner wall surface of the hollow portion in the outer end side portion 19 (an example of a second portion) adjacent to the vicinity of the inner end portion 18 (that is, Y<X).

As shown in FIGS. 4B and 5, in the present embodiment, a bottom surface 20a of the recessed portion 20 is formed as an inclined surface that is not parallel to the design surface 15 of the main body portion 10. That is, the inclined surface 20a has an inclination such that a depth of the recessed portion 20 is the deepest in the vicinity of the inner end portion 18 of the joint portion 16, and a depth of the recessed portion 20 gradually decreases from the inner end portion 18 toward the outer end portion 17 of the joint portion 16.

As shown in FIGS. 4A and 5, the airflow adjuster 23 as the end covering portion is formed as a portion (injection molded portion) joined to or integrated with the joint portion 16 so as to cover the joint portion 16 of the main body portion 10. The two cushion portions 21 and 22 provided in the main body portion 10 are injection molded together with the airflow adjuster 23. The injection molding of the airflow adjuster 23 will be described later.

Next, a manufacturing method (manufacturing procedure) of the pillar garnish 6 according to the present embodiment will be described. The manufacturing method includes at least the following three steps:
(A) a step of preparing a long main body portion 10 (main body portion preparation step);
(B) a step of setting the main body portion 10 in an injection mold (setting step); and
(C) an injection molding step of injecting a polymer material into a cavity of the injection mold after the setting step.

In the main body portion preparation step (A), the main body portion 10 as described above is molded by gas-assisted injection molding using a mold 30 as shown in FIG. 6. The mold 30 shown in FIG. 6 has a long cavity 31 corresponding to the shape of the long main body portion 10, and an inner wall of the cavity 31 is provided with a design surface forming surface 32 for forming the design surface 15 and an inclined surface forming surface 33 for forming the inclined surface 20a. An injection gate 34 is disposed near an end portion of the long cavity 31, and the inclined surface forming surface 33 is disposed to face the injection gate 34. The inclined surface forming surface 33 is inclined such that the inclined surface forming surface 33 gradually moves away from the gate 34 as it goes toward an end portion side of the cavity 31 (right side in FIG. 6), and approaches the gate 34 as it goes toward a side (left side in FIG. 6) opposite to the end portion of the cavity 31.

At the time of gas-assisted injection molding of the main body portion 10, when the polymer material fed into the cavity 31 from the injection gate 34 hits the inclined surface forming surface 33, the polymer material is guided by the inclination of the inclined surface forming surface 33 and easily flows to the end portion side of the cavity 31 (right side in FIG. 6). Therefore, most of the polymer material preferentially flows to a side opposite to the design surface forming surface 32, and the appearance of a flow mark on the design surface 15 of the main body portion after the molding is completed is prevented as much as possible. In addition, even if a flow mark appears on the inclined surface 20a, the inclined surface 20a is covered with the end covering portion (airflow adjuster 23) in a later step and is not visually recognized from the outside, so that there is no problem of poor appearance. A flow mark refers to a situation in which a trace of the flow of the molten polymer remains on the surface of the injection molded article, or a trace of the flow itself that causes poor appearance. According to the main body portion preparation step of the present embodiment, it is possible to prepare the main body portion 10 in which no clear flow mark is seen on the design surface 15.

In the subsequent setting step (B), the main body portion 10 obtained in the step (A) is set in a second injection mold (not shown). The second injection mold is an injection mold for insert molding which accommodates and holds at least a part of the main body portion 10 and has a cavity for molding the two cushion portions 21 and 22 and the airflow adjuster 23 around the set main body portion 10 (insert article).

In the subsequent injection molding step (C), an elastic polymer material for molding the cushion portions 21 and 22 and the airflow adjuster 23 is injected into and fills the cavity of the second injection mold. Thus, in the joint portion 16 of the main body portion 10, the airflow adjuster 23 is molded as the end covering portion integrated with the joint portion so as to cover the joint portion. At the same time, the two cushion portions 21 and 22 continuous with the end covering portion 23 are molded integrally with the main body portion 10.

According to the manufacturing method of the present embodiment, the vicinity of the inner end portion 18 of the joint portion 16 located at one end of the long main body portion 10 prepared in the main body portion preparation step (A) is relatively thick and has high rigidity (see X>Y in FIG. 5). Therefore, in the injection molding step (C) of injection molding the end covering portion (airflow adjuster 23) with respect to the joint portion 16 so as to cover the joint portion 16, a wall portion 10a forming the vicinity of the inner end portion 18 of the joint portion is less likely to be dented by the injection pressure of the elastic polymer material for the end covering portion. Accordingly, it is possible to prevent or reduce the generation of burrs protruding toward the design surface 15 in a joint region between the main body portion 10 and the end covering portion 23.

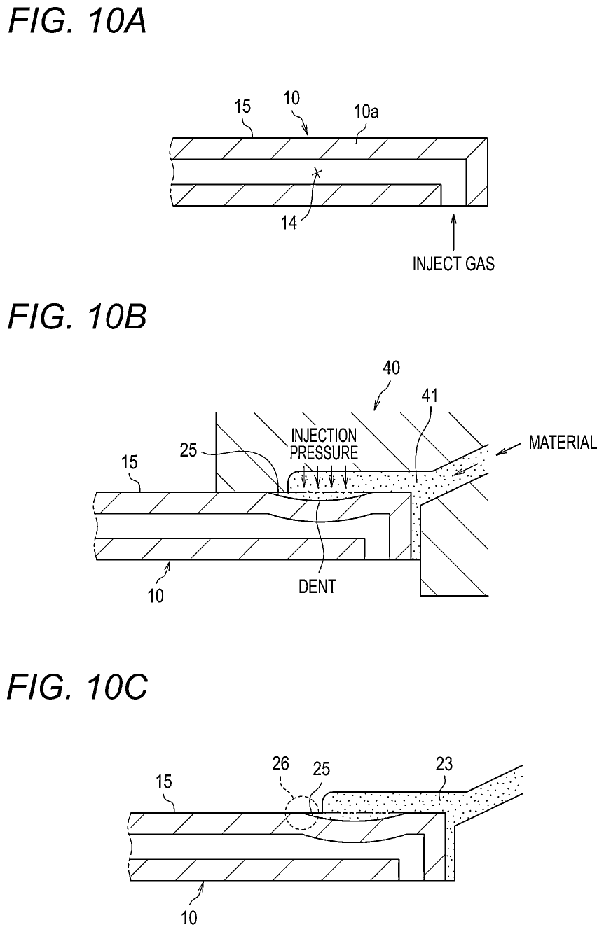

Note that the generation of “burrs protruding toward the design surface” referred to in this description will be supplementarily described with reference to FIGS. 10A to 10C. FIGS. 10A to 10C schematically show a mechanism in which problematic burrs are likely to occur in an example in the related art (that is, an example in which the thickness X in the vicinity of the inner end portion 18 of the joint portion 16 and the thickness Y in the outer end side portion 19 of the joint portion 16 shown in FIG. 5 are substantially equal).

FIG. 10A shows a cross section of a long main body portion 10 in the related art obtained by gas-assisted injection molding. Since the long hollow portion 14 is formed in the main body portion 10, the wall portion 10a of the main body portion has low rigidity. FIG. 10B shows a state in which the main body portion 10 in the related art is used as an insert article and the airflow adjuster 23 as an end covering portion is insert-molded. After the main body portion 10 is set in an insert mold 40, the elastic polymer material is injected into and fills the remaining cavity 41. At this time, a portion of the wall portion 10a of the main body portion that directly receives the injection pressure (a portion of the design surface 15) may be dented (caved in), and as a result of being dragged by this, even a portion 25 of the design surface 15 that is not covered with the airflow adjuster may also be dented. In this case, the polymer material enters not only the dent portion directly subjected to the injection pressure but also the portion 25 which is not covered by the airflow adjuster (but dented), and the polymer material is solidified as it is, resulting in a “burr 26 protruding toward the design surface” as shown in FIG. 10C.

In this regard, according to the present embodiment, the wall portion 10a forming the vicinity of the inner end portion 18 of the joint portion 16 of the main body portion 10 is thickened (increased in rigidity), and is less likely to be dented even subjected to the injection pressure at the time of injection molding of the airflow adjuster 23, so that a burr protruding toward the design surface 15 is less likely to be generated in the joint region between the main body portion 10 and the end covering portion 23.

As described above, according to the long molded article (pillar garnish 6) and the method for manufacturing the long molded article according to the present embodiment, it is possible to prevent or reduce the generation of burrs in the joint region between the main body portion 10 and the end covering portion 23.

### OTHER EMBODIMENTS

The present disclosure can also be implemented in the following embodiments.

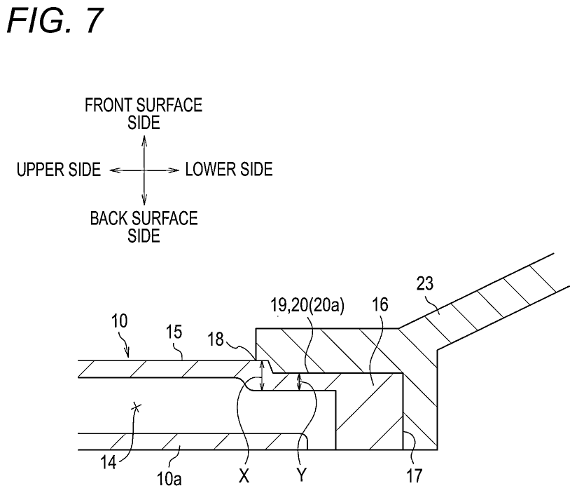

### Another Example 1/FIG. 7

In the above embodiment, the recessed portion 20 provided in the joint portion 16 of the main body portion 10 is a recessed portion having the bottom surface 20a that is an inclined surface not parallel to the design surface 15 of the main body portion as shown in FIGS. 4A, 4B and 5. Alternatively, as shown in FIG. 7, the recessed portion 20 in the joint portion 16 of the main body portion 10 may be a recessed portion having a bottom surface 20b that is a horizontal surface substantially parallel to the design surface 15 of the main body portion. According to this configuration, the injection mold for molding the main body portion 10 can be simplified as compared with the case of the above embodiment (FIG. 6).

### Overview of Another Examples 2 and 3

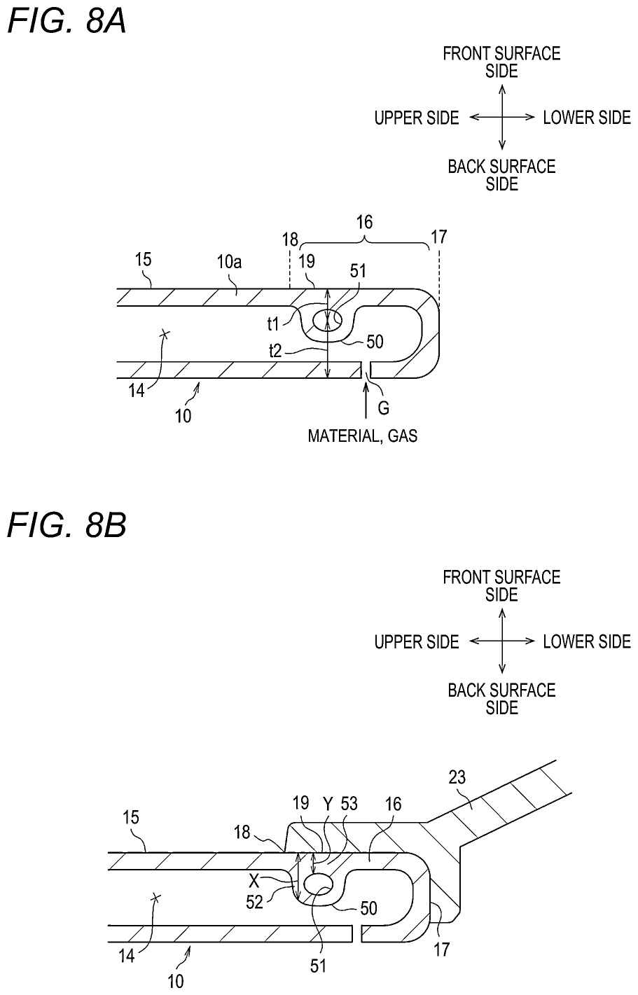

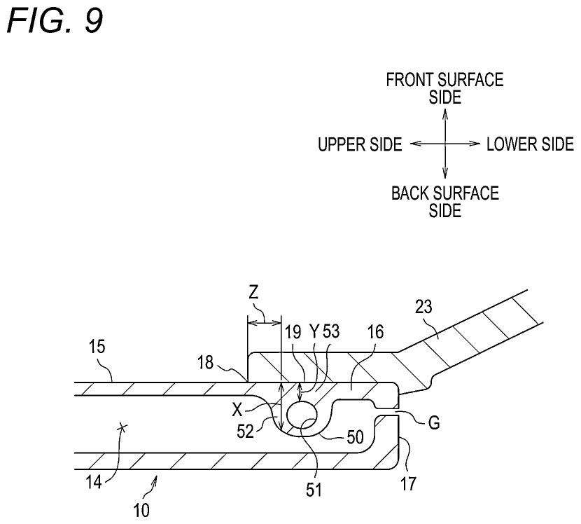

The embodiments shown in FIGS. 8A, 8B and 9 show examples in which the main body portion 10 is injection molded by “gas-assisted injection molding using a pin” instead of normal gas-assisted injection molding adopted in the main body portion preparation step (A) of the above embodiment (FIGS. 4A to 6).

### Another Example 2/FIGS. 8A and 8B

FIG. 8A shows a cross section of the vicinity of the end of the main body portion 10 obtained by gas-assisted injection molding using a pin. As shown in the drawing, an inner wall surface of the wall portion 10a (the back surface side of the joint portion 16) that defines the hollow portion 14 in the vicinity of the inner end portion 18 of the joint portion 16 of the main body portion is provided with a convex portion 50 that encloses a hollow 51. The hollow 51 inside the convex portion 50 is a removal mark of a pin (not shown). Such a convex portion 50 is obtained by setting a pin (that is, a bar that can be removed from the cavity afterwards) in advance in a cavity of an injection mold for the main body portion so as to be orthogonal to the paper surface of the drawing, and then injecting a polymer material together with a gas into the cavity to fill the cavity.

A set position of the pin in the long cavity for molding the main body portion is a position eccentric from a central axis in the longitudinal direction of the cavity toward a forming surface (mold surface) side (front surface side) of the design surface 15, that is, a position at distance t1 shown in FIG. 8A (here, t1+t2=an inner diameter of the cavity at the position, and a relationship of t1<t2 is satisfied). When the gas-assisted injection molding is performed in a state where the pin is eccentrically disposed at the distance t1, the polymer material fed into the cavity from the injection gate G fills the cavity, and the gas fed into the cavity after the polymer material passes through the back surface side of the pin and enters the cavity toward a deep inside thereof while avoiding (bypassing) the pin, thereby forming the convex portion 50 having the pin as the core. Thus, the main body portion 10 having a cross-sectional structure as shown in FIG. 8A is molded.

FIG. 8B shows a state in which the airflow adjuster 23 is insert-molded in the main body portion 10 of FIG. 8A in the same manner as in the above embodiment (FIGS. 4A to 6). As can be seen from FIG. 8B, in the vicinity of the inner end portion 18 of the joint portion 16 of the main body portion 10, there is a vertical wall 52 (a wall portion located on the left side of the hollow 51 in the figure) forming the convex portion 50. The thickness (X) at this position of the vertical wall 52 in a vertical direction can be regarded as the thickness (X) between the outer surface of the main body portion and the inner wall surface of the hollow portion in the vicinity of the inner end portion 18 of the joint portion 16. Further, in the outer end side portion 19 adjacent to the vicinity of the inner end portion 18 of the joint portion 16, there is a ceiling wall 53 (a wall portion located on the upper side of the hollow 51 in the figure) forming the convex portion 50. The thickness (Y) of the ceiling wall 53 in the vertical direction can be regarded as the thickness (Y) between the outer surface of the main body portion and the inner wall surface of the hollow portion in the outer end side portion 19. The thickness (X) at this position of the vertical wall 52 in the vertical direction is larger than the thickness (Y) of the ceiling wall 53 in the vertical direction (that is, Y<X).

Accordingly, in the embodiment shown in FIGS. 8A and 8B, similarly to the above embodiment (FIGS. 4A to 6), the wall portion 10a forming the vicinity of the inner end portion 18 of the joint portion 16 of the main body portion 10 is thickened (increased in rigidity), and is less likely to be dented even subjected to the injection pressure at the time of injection molding of the airflow adjuster 23. Therefore, it is possible to prevent or reduce the generation of burrs protruding toward the design surface 15 in a joint region between the main body portion 10 and the end covering portion 23.

### Another Example 3/FIG. 9

The embodiment shown in FIG. 9 is basically the same as the embodiment shown in FIGS. 8A and 8B, but is different in that the position of the injection gate G when the main body portion 10 is subjected to the “gas-assisted injection molding using a pin” is set on an end surface side of an end portion of the long main body portion 10. Therefore, as shown in FIG. 9, the airflow adjuster 23 is formed at the joint portion 16 of the main body portion 10 so as not to cover the injection gate G on the end surface of the main body portion.

In FIG. 9, the vertical wall 52 having the thickness (X) in the vertical direction that can be regarded as the thickness (X) between the outer surface of the main body portion and the inner wall surface of the hollow portion in the vicinity of the inner end portion 18 of the joint portion 16 may be located at a position away from the inner end portion 18 by a distance Z, and the position of the vertical wall 52 is included in “the vicinity of the inner end portion 18 of the joint portion 16” as long as Z is about 2 mm or less.

By adopting the “gas-assisted injection molding using a pin” in the embodiment shown in FIGS. 8A, 8B and 9, the polymer material fed into the cavity from the injection gate hits the pin, whereby a flow of the polymer material is controlled. Consequently, it is possible to prevent or reduce the occurrence of a poor appearance such as a flow mark or a jetting mark on the design surface 15 of the main body portion 10.

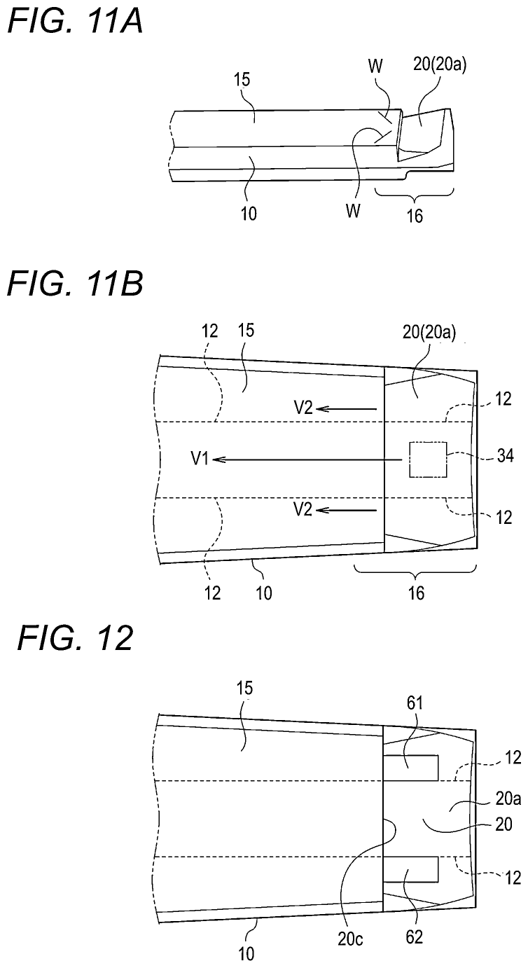

### Another Example 4/FIGS. 11A to 13

When the main body portion 10 of the pillar garnish 6 as shown in FIGS. 4A, 4B and 5 is molded by the gas-assisted injection molding as shown in FIG. 6, there is a possibility that an unintended weld line W (shown by two lines of a truncated chevron shape in the figure) occurs on the design surface 15 near the end of the main body portion 10 as shown in FIG. 11A. The weld line W is a linear minute recess, which deteriorates the design of the design surface 15. It is considered that the weld lines W occur on the design surface 15 due to the circumstances (i) to (iii) as follows:
(i) at the time of gas-assisted injection molding of the main body portion 10, a flow of the molten polymer material injected into the cavity 31 of the mold 30 from the gate 34 (see FIG. 6, the corresponding position is indicated by a two-dot chain line in FIG. 11B) changes when the molten polymer material passes over the inclined surface forming surface 33 (a portion of the mold for forming the recessed portion 20);
(ii) in the mold 30, a volume of the cavity for forming the body portion 12 (that is, a central portion in the width direction of the main body portion 10, the corresponding position is indicated by a broken line in FIG. 11B) of the main body portion is larger than a volume of each of two left and right cavities for forming a portion other than the body portion (that is, both side portions of the head portion 11 exist so as to sandwich the central portion in the width direction of the main body portion 10); and
(iii) for this reason, as suggested in FIG. 11B, when the polymer material exceeds the inclined surface forming surface 33 of the mold 30, a flow rate V1 of the polymer material at a center position in the width direction of the cavity 31 of the mold becomes faster than a flow rate V2 of the polymer material at both side positions of the center position in the width direction (V2<V1), that is, a flow rate difference (V1−V2) becomes large between the center position in the width direction and both side positions thereof.

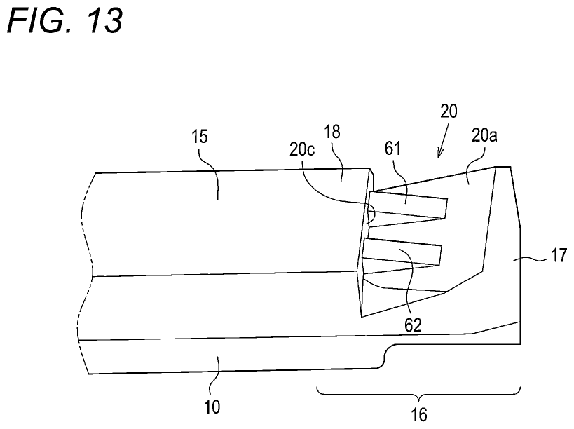

In order to prevent the generation of the weld line in advance, improvement measures as shown in FIGS. 12 and 13 are taken under the idea of eliminating the above-described flow rate difference (V1−V2) as much as possible (that is, achieving equalization of the flow rates V1 and V2). Similarly to the main body portion 10 shown in FIGS. 3, 4A, 4B and 5, the main body portion 10 shown in FIGS. 12 and 13 includes the head portion 11, the body portion 12, and the leg portion 13 which are arranged in this order from the front surface side to the back surface side. The hollow portion 14 extending in the longitudinal direction is mainly formed at the center position of the body portion 12, and the design surface 15 (exposed surface 15 exposed to the outside) is provided by the upper surface of the head portion 11. Further, the joint portion 16 of the main body portion 10 includes the outer end portion 17 and the inner end portion 18, and the recessed portion 20 recessed with respect to the surface of the inner end portion 18 (or the design surface 15 continuous with the surface of the inner end portion) is also formed on the front surface side of the joint portion 16.

As shown in FIGS. 12 and 13, the recessed portion 20 at the end of the main body portion 10 is a recessed region defined by an inclined bottom surface (inclined surface 20a) and a standing surface (the standing surface is referred to as a “stepped surface 20c”) rising substantially perpendicularly from a base end edge (one side of a root portion) of the inclined surface 20a. In Another Example 4, a pair of lump portions 61 and 62 (drawn as substantially wedge-shaped pieces in FIG. 13) are formed in a region where the recessed portion 20 is formed. Each of the lump portions 61 and 62 is formed as a connecting portion that connects the inclined surface 20a of the recessed portion and the stepped surface 20c. Both of the two lump portions 61 and 62 are disposed not at positions facing the body portion 12 of the main body portion, but at positions other than the facing positions (see FIG. 12). More specifically, the two lump portions 61 and 62 are disposed at positions on an outer surface (mainly the inclined surface 20a) of the recessed portion 20 which are corresponding to portions adjacent to both left and right sides of a central portion of the head portion that faces the body portion 12 of the main body portion (that is, portions not facing the body portion 12 of the main body portion). By designing such a pair of lump portions 61 and 62 to be disposed in a region where the recessed portion 20 is formed, the pair of lump portions function as a communication passage that bypasses the flow of the polymer material at the time of gas-assisted injection molding of the main body portion 10. As a result, the flow rate V1 of the polymer material at the center position in the width direction of the cavity 31 of the mold and the flow rate V2 of the polymer material at both side positions of the center position in the width direction described in (iii) are equalized. By reducing the flow rate difference (V1-V2) in this manner, the generation of the weld line W is prevented (at least the generation of a clearly visible weld line is avoided). It is confirmed through prototype experiments that the closer the position of each lump portion 61, 62 is to the central portion of the head portion facing the body portion 12, the better the effect. It is also confirmed that the effect of preventing weld line tends to increase as a width of each of the lump portions 61 and 62 increases, and further increases when each of the lump portions 61 and 62 is formed across the entire width of the portion that does not face the body portion 12 of the main body portion.

The idea of “disposing a lump portion in the region where the recessed portion is formed” described in Another Example 4 can also be applied to the main body portion 10 having the recessed portion (the recessed portion 20 whose bottom surface is a horizontal surface 20b) as in Another Example 1 (FIG. 7).

What is claimed is:

1. A long molded article comprising:
a main body portion extending in a longitudinal direction; and
an end covering portion located at one end of the main body portion in the longitudinal direction,
wherein the main body portion comprises a wall portion,
wherein the wall portion comprises an outer surface on an outer side of the wall portion and an inner wall surface on an inner side of the wall portion, a part of the outer surface defining an exposed surface exposed to an outside of the long molded article, the inner wall surface defining a hollow portion formed inside the main body portion and extending along the longitudinal direction,
wherein a joint portion configured to be joined to the end covering portion is provided in a part of the wall portion at the one end of the main body portion, the part of the wall portion defining one end portion of the hollow portion in the longitudinal direction or a vicinity of the one end portion,
wherein the end covering portion is an injection molded portion, the injection molded portion being made of an elastic polymer material having a hardness lower than a material constituting the main body portion and being integrated with the joint portion while covering the joint portion,
wherein the joint portion comprises an outer end portion and an inner end portion, the inner end portion being located opposite to the outer end portion in the longitudinal direction and being adjacent to the exposed surface, and
wherein a first thickness between the outer surface and the inner wall surface in a first portion of the joint portion, the first portion being located in a vicinity of the inner end portion of the joint portion, is set to be thicker than a second thickness between the outer surface and the inner wall surface in a second portion of the joint portion, the second portion being located adjacent to the first portion of the joint portion on an outer end portion side relative to the first portion.

2. The long molded article according to claim 1, wherein the outer surface has a recessed portion formed in the second portion of the joint portion and recessed relative to the inner end portion of the joint portion such that the inner end portion is made thicker than the second portion.

3. The long molded article according to claim 2,
wherein the wall portion forms at least a head portion and a body portion on a back surface side of the head portion,
wherein a part of the head portion forming the outer surface defines the exposed surface, and
wherein in a region where the recessed portion is formed, a lump portion is formed at a position of the outer surface corresponding to a portion that does not face the body portion.

4. A method for manufacturing a long molded article, the method comprising:
preparing a main body portion extending in a longitudinal direction, wherein:
the main body portion comprises a wall portion,
the wall portion comprises an outer surface on an outer side of the wall portion and an inner wall surface on an inner side of the wall portion, a part of the outer surface defining an exposed surface to be exposed to an outside of the long molded article, the inner wall surface defining a hollow portion formed inside the main body portion and extending along the longitudinal direction,
a joint portion is provided in a part of the wall portion at one end of the main body portion in the longitudinal direction, the part of the wall portion defining one end portion of the hollow portion in the longitudinal direction or a vicinity of the one end portion, and
the joint portion comprises an outer end portion and an inner end portion, the inner end portion being located opposite to the outer end portion in the longitudinal direction and adjacent to the exposed surface, and
a first thickness between the outer surface and the inner wall surface in a first portion of the joint portion, the first portion being located in a vicinity of the inner end portion of the joint portion, is set to be thicker than a second thickness between the outer surface and the inner wall surface in a second portion of the joint portion, the second portion being located adjacent to the first portion of the joint portion on an outer end portion side relative to the first portion;
setting the main body portion in an injection mold, the injection mold having a cavity configured to mold an end covering portion to be located at the one end of the main body portion; and
injecting a polymer material into the cavity of the injection mold after the setting the main body portion in the injection mold, the polymer material being an elastic polymer material having a hardness lower than that of a material constituting the main body portion, to injection mold the end covering portion using the polymer material such that the end covering portion is integrated with the joint portion while covering the joint portion.

5. The method according to claim 4, wherein in the preparing the main body portion, the main body portion is prepared by gas-assisted injection molding.

6. The method according to claim 4, wherein the outer surface has a recessed portion formed in the second portion of the joint portion and recessed relative to the inner end portion of the joint portion such that the inner end portion is made thicker than the second portion.

7. The method according to claim 6, wherein the preparing the main body portion comprises injection molding the main body portion such that the recessed portion comprises a bottom surface formed as an inclined surface non-parallel to the exposed surface.

8. The method according to claim 6,
wherein the wall portion forms at least a head portion and a body portion on a back surface side of the head portion,
wherein a part of the head portion forming the outer surface defines the exposed surface, and
wherein in a region where the recessed portion is formed, a lump portion is formed at a position of the outer surface corresponding to a portion that does not face the body portion.
